(19) United States
(12) Patent Application Publication
(10) Pub. No.: US 2007/0220562 A1
(43) Pub. Date: Sep. 20, 2007

(54) METHOD AND APPARATUS FOR SELECTIVELY RENDERING MEDIA CONTENT ON REMOTE DISPLAYS

(75) Inventors: Craig A. Janssen, St. Charles, IL (US); Nitya Narasimhan, Lake Zurich, IL (US); Michael D. Pearce, Barrington, IL (US); Yibing Song, New York, NY (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,515

(22) Filed: Mar. 3, 2006

(51) Int. Cl. H04N 7/167; H04N 7/16; H04N 7/18

(52) U.S. Cl. 725/81; 725/25; 725/31

(57) ABSTRACT

An apparatus and method (300-400) are disclosed for selectively rendering media content on remote displays (604-612). An apparatus that incorporates teachings of the present disclosure may include, for example, a communication device (100) having a controller (106) that manages operations of a wireless transceiver (102). The controller can be programmed to detect (402) a display server (200) in a wireless local area network, receive (410) from the display server its capabilities for presenting content, create (414-418) displayable content conforming to the capabilities of the display server, and transmit (420) the displayable content to the display server. Additional embodiments are disclosed.

### FIELD OF THE DISCLOSURE

The present disclosure relates generally to display technologies, and more specifically to a method and apparatus for selectively rendering media content on remote displays.

### BACKGROUND

The capabilities of mobile communication devices such as cellular phones continue to increase with central processing and local storage resources on the leading edge. Additionally, displays have improved from the days of monochrome low resolution liquid crystal displays (LCDs). It is common today, for example, for midtier mobile devices to utilize high resolution color displays such as Thin Film Transistor (TFT) LCDs. Despite these improvements, display usability for mobile devices remains a deficiency in the art that needs resolution.

Displays sizes for mobile devices are either too small, or inconveniently placed. There are instances, for example, when large conventional displays such as those used by digital television sets and flat panel computer displays would be more convenient for viewing multimedia files (e.g., still or video images) than by way of a small screen of a cell phone. In other situations, end users may carry their mobile devices in an inconvenient location (e.g., a purse, or backpack) and miss important events such as a phone call or calendar event because they do not readily hear or see the alert.

A need therefore arises for a method and apparatus that can overcome the aforementioned deficiencies in the prior art.

### BRIEF DESCRIPTION OF THE DRAWINGS

FIG. 1 depicts an exemplary embodiment of a wireless communication device (WCD);

FIG. 2 depicts an exemplary embodiment of a display server;

FIG. 3 depicts a flowchart of an exemplary method operating in the display server;

FIG. 4 depicts a flowchart of an exemplary method operating in the WCD;

FIG. 5 depicts an exemplary representation of communications taking place between the display server and WCD;

FIG. 6 depicts exemplary embodiments of the display server and WCD; and

FIG. 7 depicts an exemplary diagrammatic representation of a machine in the form of a computer system within which a set of instructions, when executed, may cause the machine to perform any one or more of the methodologies disclosed herein.

### DETAILED DESCRIPTION

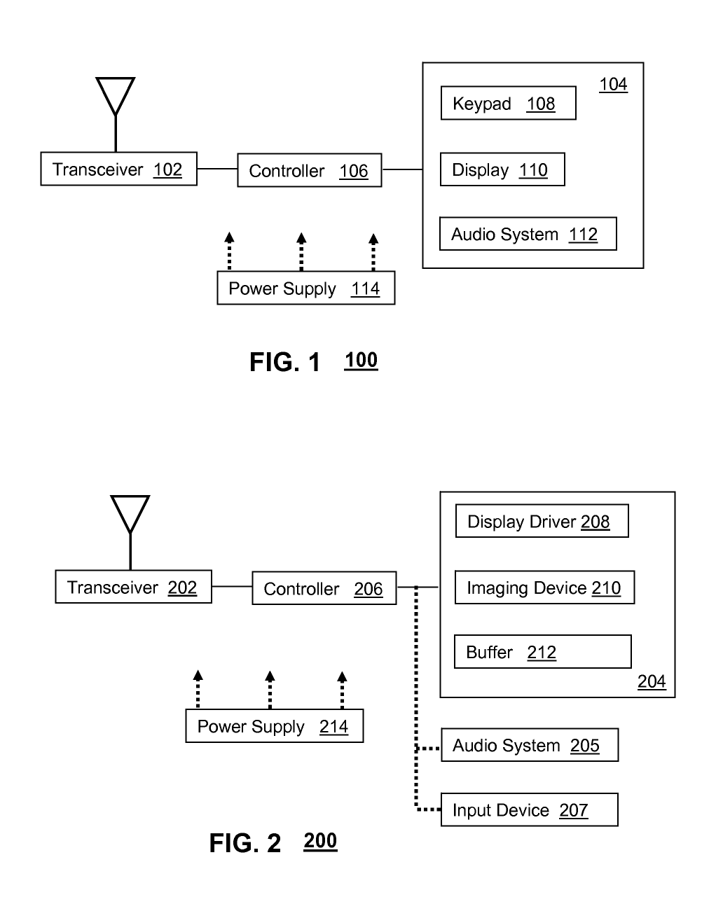

FIG. 1 depicts an exemplary embodiment of a wireless communication device (WCD) 100. The WCD 100 can comprise a wireless transceiver 102, a user interface (UI) 104, a power supply 114, and a controller 106 for managing operations of the foregoing components. The wireless transceiver 102 can utilize common communication technologies to support singly or in combination any number of wireless access technologies including without limitation Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing public and private communication spectrum with any number of communication protocols that can be dynamically downloaded over-the-air to the WCD 100. It should be noted also that next generation wireless access technologies can also be applied to the present disclosure.

The UI 104 can include a keypad 108 with depressible or touch sensitive keys and a navigation disk for manipulating operations of the WCD 100. The UI 104 can further include a display 110 such as monochrome or color LCD (Liquid Crystal Display) for conveying images to the end user of the WCD 100, and an audio system 112 that utilizes common audio technology for conveying and intercepting audible signals of the end user.

The power supply 114 can utilize common power management technologies such as replaceable batteries, supply regulation technologies, and charging system technologies for supplying energy to the components of the WCD 100 and to facilitate portable applications. The controller 106 can utilize computing technologies such as a microprocessor and/or digital signal processor (DSP) with associated storage memory such a Flash, ROM, RAM, SRAM, DRAM or other like technologies for controlling operations of the WCD 100.

It would be evident to an artisan with ordinary skill in the art that the abovementioned components of the WCD 100 can be modified or enhanced to meet the needs of an end user without departing from the scope of the present disclosure.

FIG. 2 depicts an exemplary embodiment of a display server 200. The display server 200 can include a wireless transceiver 202, a display 204, a power supply 214 and a controller 206 for controlling operations thereof The wireless transceiver 202 can operate according to any of the aforementioned access technologies for the WCD 100. The display 204 can include a display driver 208, an imaging device 210, and a buffer 212.

The display driver 208 can utilize common technology for processing images presented on the imaging device 210. The imaging device 210 can utilize common imaging technology such as a Thin Film Transistor liquid crystal display (TFT LCD) for conveying to an end user color images with text and/or graphics. The buffer 212 represents a storage device with volatile (e.g., RAM) and/or nonvolatile memory (e.g., Flash) which can be a separate or integral part of the display driver 208 for processing images received from other devices.

The power supply 214 can represent a fixed adapter coupled to an AC outlet for supplying DC power to the components of the display driver 200. Alternatively, the power supply 214 can be a portable power supply utilizing similar technologies as described earlier for the WCD 100. The controller 214 can also utilize computing technology similar to the WCD 100 for controlling operations of the display server 200 and for applying common algorithms to conserve battery consumption in portable applications.

In a supplemental embodiment, the display server 100 can further include an audio system 205 that utilizes common technologies for conveying and/or intercepting audible signals of an end user. With the addition of the audio system 205, the display server 200 can serve as a media server with the capability to present media content of all types as well as exchange audible signals with the end user. The display server 200 can also include an input device 207 (such as a keypad with buttons, a touch-screen, and/or joystick) for accepting an end user's responses to the displayed content.

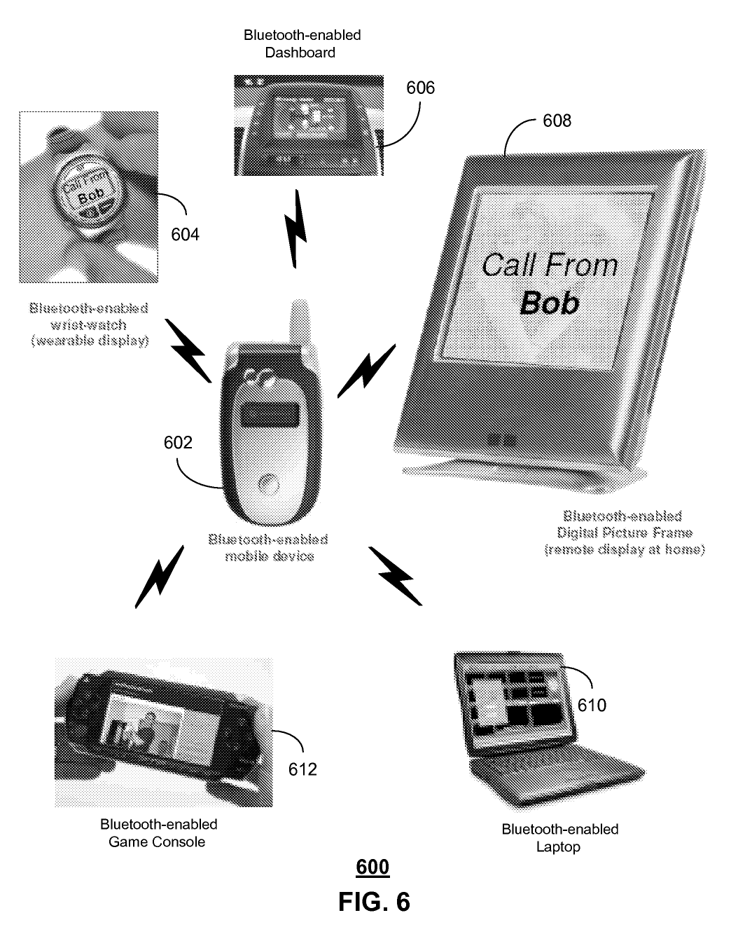

The foregoing components of the display server 100 can be modified, miniaturized, or enhanced so that it can be carried in any number of embodiments such as, for example, a wristwatch, a personal digital assistant (PDA), an automobile dashboard or console, a television set, a flat panel digital or analog display of a computer, a small or large entertainment system, or a security system in a residence or enterprise—just to mention a few (see some illustrations in FIG. 6).

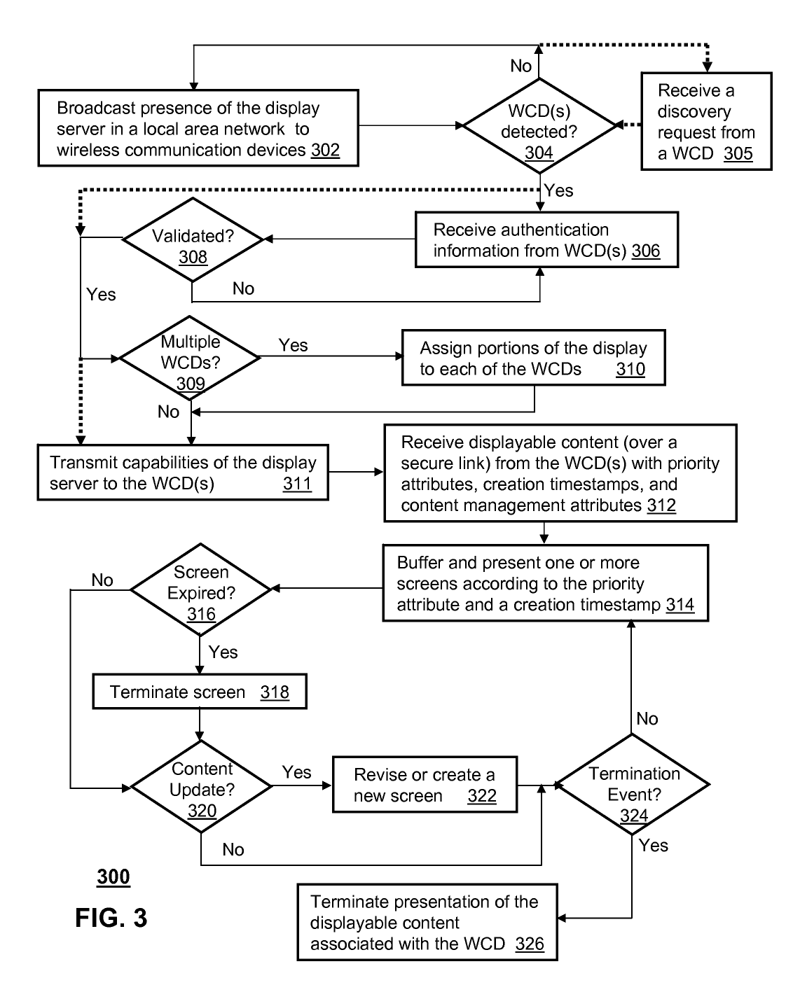

FIG. 3 depicts a flowchart of an exemplary method 300 operating in the display server 200. Method 300 can begin with step 302 in which the controller 206 directs the wireless transceiver 202 to broadcast presence information associated with the display server 200 in a wireless local area network (e.g., Bluetooth) in which WCDs 100 may be roaming. The presence information can include any identifier that may be useful to a WCD 100 in detecting the display server 200. For resource constraint display servers 200 (like a wristwatch), the controller 206 can be alternately programmed in step 305 to await a discovery request from a WCD 100 to conserve battery power. If in either case a WCD 100 is not detected in step 304, the controller 206 continues to broadcast presence information in step 302, or awaits a discovery request from a roaming WCD 100. If a WCD 100 is detected in step 304, the controller 206 proceeds to step 306 where it awaits reception of authentication information from the WCD 100.

The authentication information received from the WCD 100 can include, for example, information that identifies the WCD 100 as an appropriate candidate for utilizing the resources of the display server 200. Alternatively, or in combination, the authentication information can include security information such as a login and password. In step 308, the controller 206 checks for the validity of the authentication information according to pre-stored compatibility information relating to WCDs 100, and/or login and passwords. If the authentication information supplied by the WCD 100 is invalid, the controller 206 returns to step 306 where it communicates this state to the WCD 100. In the case of a login and password invalidation, the controller 206 can be programmed to await in step 306 for one or more additional attempts by the WCD 100 to supply valid entries. Although not shown, if too many attempts are made by the WCD 100, the controller can be programmed to cease communications with the WCD.

Once the authentication information has been validated in step 308, the controller 206 proceeds to step 309 where it checks for the presence of one or more WCDs 100 requesting the resources of the display server 200. If multiple WCDs 100 are detected, the controller 206 can be programmed to proceed to step 310 where it assigns temporal and/or spatial portions of the display 204 to each of the WCDs 100. In the case of temporal portions, the controller 206 can assign time slots for usage of the display 204 to each of the WCDs 100, while in the case of spatial portions, the controller 206 can assign physical portions of the display 204 to each of the WCDs 100. The temporal or spatial portions can be equal, or asymmetrical depending on the WCD's 100 needs, and priority which may be determined from the authentication information supplied thereby.

Alternatively, or in combination, the controller 206 can be programmed to always process a single WCD 100 on a first-come first-serve basis with a temporal limit to avoid excessive use, or according to a specific authentication associated with a single end user. In a single WCD 100 embodiment, the controller 206 can be programmed to bypass step 309 and proceed directly to step 311.

For single or multiple WCDs 100 seeking access to the display server 200, the controller 206 proceeds to step 311 where it transmits its complete resource capabilities to the single WCD 100, or in the case of multiple WCDs 100 its partial capabilities according to the spatial and/or temporal portions allocated respectively to each WCD 100. The capabilities publicized to the WCD 100 in step 311 can include among other things a display type (TFT v. CRT v. Plasma, etc.), a display resolution (Quarter VGA, VGA, Super VGA, etc.), one or more display dimensions (X, Y and diagonal dimensions), one or more content types supported by the display (still and/or moving images), display speed (8 ms v. 16 ms), display contrast ratio (450:1 v. 700:1), one or more color parameters (16 bit v. 32 bit), audio capabilities (if the audio system 205 is available), user input capabilities (if the input device 207 is available), and/or one or more interaction capabilities such as will be described below.

For convenience, the steps following step 311 will be described according to a single WCD 100 embodiment. It would be evident to one of ordinary skill in the art that steps 312 through 326 can be applied in multiple instances to each of a plurality of WCDs 100.

Accordingly, once the capabilities of the display server 200 have been conveyed to the WCD 100 in step 311, the controller 206 proceeds to step 312 where it awaits reception of displayable content tailored by the WCD 100 to the capabilities of the display server 200. It should be noted that the displayable content in this step can include an audio component in cases where the display server 200 has an audio system 205, and interaction commands if the input device 207 is also available. For convenience, the term “displayable content” will continue to the used below with an understanding that depending on the capabilities of the display server 200 it can represent media content having a visual component, audio component, interaction commands, and combinations thereof.

It is further noted that the displayable content can also be accompanied by priority attributes, creation timestamps, and/or content management attributes. The priority attributes and creation timestamps can be utilized for defining an order of priority for the presentation of multiple screens. The content management attributes can include for each screen of displayable content a presentation time limit and/or a queuing time limit in the buffer 212.

Subsequent to step 311, the communication exchange between the WCD 100 and the wireless transceiver 202 of the display server 200 can be secured by the controller 206 by common means such as WiFi Protected Access (WPA) configured for low to high security encryption in order to prevent unauthorized access to the displayable content. The request for security can come from the display server 200, the WCD 100, or as a default setting in the display server 200 established at a prior time by the end user of the WCD 100. Alternatively, communications can take place without a secure link if the information exchanged does not need to be secured.

Once the displayable content is received in step 312, the controller 206 proceeds to step 314 where it buffers and presents one or more screens of displayable content on the imaging device 210 according to the priority attributes and/or the creation timestamps. The displayable content can include any form of content such as, for example, text (e.g., an SMS message—Short Message Service), still images (e.g., JPEG or GIF), video (e.g., WAV file), flash media, or combinations thereof. Once buffered, the displayable content is refreshed automatically by the display driver 208 until such time that the content is updated or terminated by a termination event in step 324.

In step 316, the controller 206 can be programmed to check whether any of the screens have expired according to one or more timers tracking the presentation time limit and/or queuing time limit established by the content management attributes. If these time limits have not expired, the controller 206 proceeds to step 320. Otherwise, the controller 206 proceeds to step 318 where it terminates the screen. Termination of a screen can include a purge of the buffers and/or a termination of presentation of content on the imaging device 210.

In step 320, the controller 206 checks for updates to the displayable content submitted by the WCD 100. If there is no update, the controller 206 proceeds to step 324. If an update is detected, the controller 206 proceeds to step 322 where it revises the current screen with the updated content, or creates a new screen with new content as directed by the WCD 100.

In step 324, the controller 206 checks whether a termination event has occurred. A termination event can occur from the WCD 100 proactively requesting a termination of communications with the display server 200. Alternatively, a termination event can occur from a loss of communications with the WCD 100 (e.g., the WCD 100 is out of range). In yet another embodiment, a termination event can occur from the expiration of the presentation and queuing timers discussed in step 316. The controller 206 can be programmed with any combination of the foregoing events, or other suitable events not discussed herein that can be utilized for terminating a session between the display server 200 and the WCD 100. Once a termination event is detected, the controller 206 can proceed to step 326 where it terminates presentation and queuing of all displayable content associated with the WCD 100.

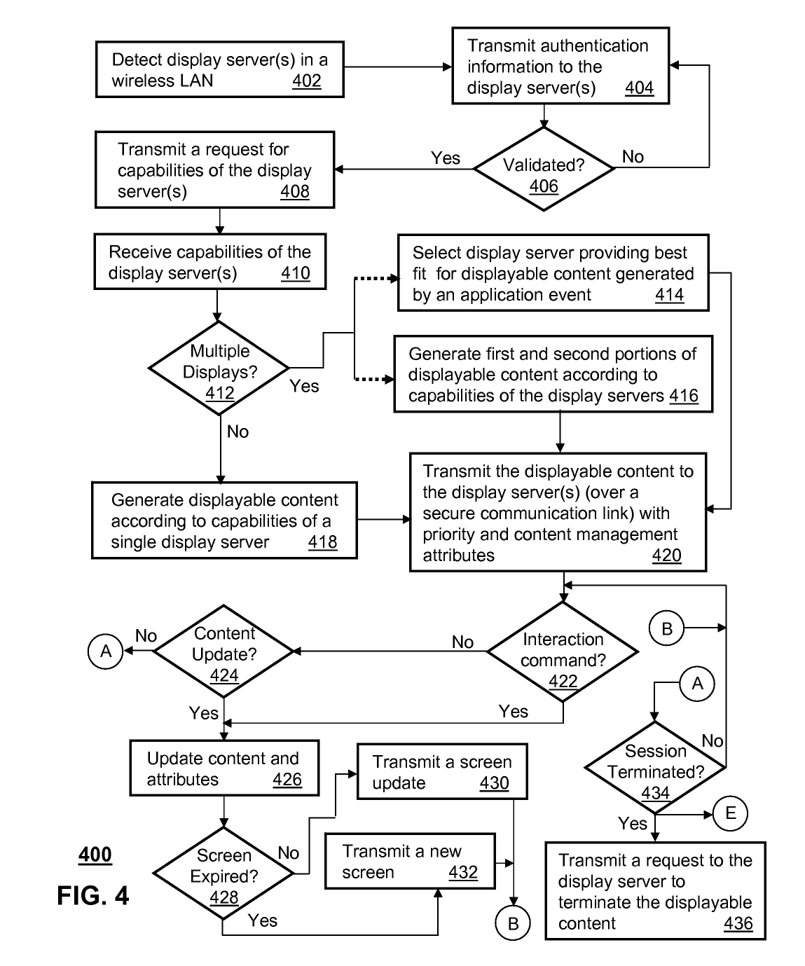

FIG. 4 depicts a flowchart of an exemplary method 400 operating in the WCD 100. Method 400 can begin with step 402 where the controller 106 of the WCD 100 detects one or more display servers 200 in the wireless LAN (e.g., Bluetooth™). The detection step can occur from a broadcast of presence information transmitted by the display server 200 as in step 302, or from the WCD 100 polling for display servers 200 by transmitting a discovery request. Upon detecting a display server 200, the controller 106 can be programmed to transmit in step 404 authentication information to the display server(s) 200 and await a validation from the display server 200 much like what was described in method 300. Upon validation, the controller 106 can be programmed to transmit in step 408 a request directed to the display server(s) 200 for its imaging capabilities.

Upon receiving capability information from the display server(s) 200 in step 410, the controller 106 proceeds to step 412 where checks whether two or more display servers 200 are available. If only a single display server 200 is detected, the controller 106 proceeds to step 418 where it generates displayable content from an application event (e.g., receiving an SMS message, receiving an incoming call, etc.) according to the capabilities of the detected display server 200. If, for example, two display servers 200 are detected, the controller 106 can proceed to one of two steps. In a first embodiment, the controller 106 proceeds to step 414 where it selects one among the display servers 200 that best suits the displayable content generated by the given application event.

Alternatively, the controller 106 can proceed to step 416 where it can selectively generate first and second portions of displayable content generated by one or more application events. In this embodiment, each portion of the displayable content is tailored to the capabilities of each display server 200, respectively. This latter embodiment provides the end user of the WCD 100 a means to visualize displayable content on multiple screens and/or listen and respond to audible and visual content if an audible and input component is included with the visual portions.

From step 414, 416 or 418, the controller 106 proceeds to step 420 where it transmits the displayable content with priority attributes, creation timestamps, and content management attributes to the display server(s) 200. This and subsequent communications can take place under a secure communications link with WPA if the end user of the WCD 100 does not want others to gain access to the information transmitted, or without security if confidentiality is not required.

In step 422, the controller 106 can be programmed to check for interaction commands received from the display server 200. The interaction commands can come from the input device 207 (e.g., a keypad, mouse, joystick, etc.) of the display server 200 (if available) according to tactile responses supplied by the end user. If an interaction command is detected, the controller 106 can proceed to step 426 where it updates the displayable content according to the interaction command(s) received, and creates corresponding priority and content management attributes with one or more creation timestamps. If there are no interaction commands received (because perhaps an input device 207 is not available or the end user supplied no tactile responses), the controller 206 proceeds to step 424 where it checks for updates to the displayable content as directed by the application operating in the controller 106 that controls said content.

If there are no updates, the controller 106 proceeds to step 434 where it checks whether the session is being terminated by the application generating the content. In this step, the controller 106 determines from the software application that generated displayable content whether the resources of the display server(s) 200 is still needed. If the resources continue to be required, the controller 106 proceeds to step 422 where it repeats the aforementioned process.

If the resources are no longer required, the controller 106 can be programmed to transmit a request to the display server 200 to terminate the displayable content. Alternatively, the controller 106 can be programmed to cease interactions with the display server 200. In this case, the presentation and/or queuing time limits once expired can trigger the display server 200 to purge the displayable content without direction from the WCD 100. If the WCD 100 moves and is out of the wireless communication range of the display server 200, the display server 200 can be triggered to purge the displayable content also.

Referring back to steps 422-424, if interaction commands are detected in step 422, or a content update is detected in step 424, the controller 106 proceeds to step 426 where it updates the content according to an application update and/or an interaction command update as just described. In step 428, the controller 106 checks if the screen has expired according to its presentation or queuing time limit. If it has, the controller 106 proceeds to step 432 where it transmits a new screen with the updated content, attributes and a creation timestamp. Otherwise, the controller 106 proceeds to step 430 where it transmits a screen update with associated attributes and a creation timestamp. Once the update is transmitted to the display server 200, the controller 106 proceeds to step 422 where it repeats the cycle just described.

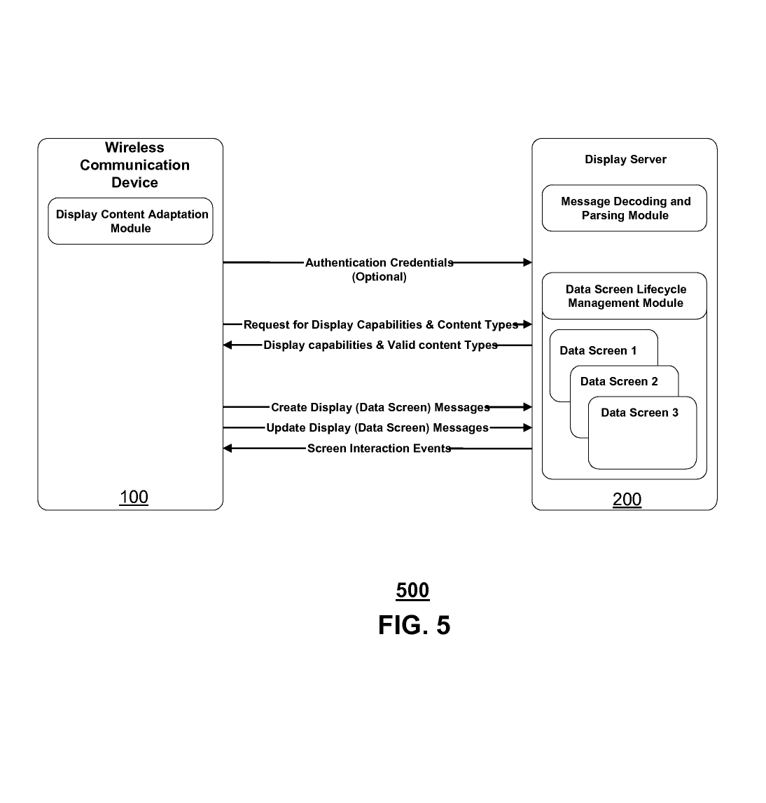

FIG. 5 depicts an exemplary representation 500 of communication exchanges taking place between the display server 200 and the WCD 100 in accordance with methods 300-400. Similarly, FIG. 6 depicts exemplary embodiments of the display server 200 and the WCD 100. In this illustration, cellular phone 602 can represent a common WCD 100 capable of cellular and Bluetooth communications. By way of Bluetooth, the cellular phone 602 can communicate with any of the Bluetooth-enabled display servers 200 shown (604-612). The display servers 200 can in turn convey displayable content of the cellular phone 602 when it affords a convenience to the end user to do so. For instance, an SMS message can be viewed on a Bluetooth-enabled wristwatch 604 while an end user of the WCD 100 (cellular phone 602) is mobile and unable to readily retrieve the WCD 100 in real-time (e.g., while attached to a belt-clip). In another use case, presenting images such as a caller ID of an incoming call on the wristwatch with an audible alert can be useful when the end user has stored the WCD 100 in a purse, backpack or other carryon item.

It should be noted that a display server 200 can in some circumstances represent a WCD 100, and vice-versa. For example, a Bluetooth-enable laptop 610 can in a first instance operate as a display server 200 for the WCD 100 embodied as cellular phone 602. Alternatively, the Bluetooth-enabled laptop 610 can represent a WCD 100 while other devices such as the Bluetooth-enabled digital picture frame 608 can extend the display capabilities of the laptop 610 as a display server 200.

From the above descriptions it should be evident to artisans with ordinary skill in the art that there are countless ways to modify and enhance the foregoing written and exemplary disclosures of FIGS. 1-6 without departing from the scope and spirit of the claims described below.

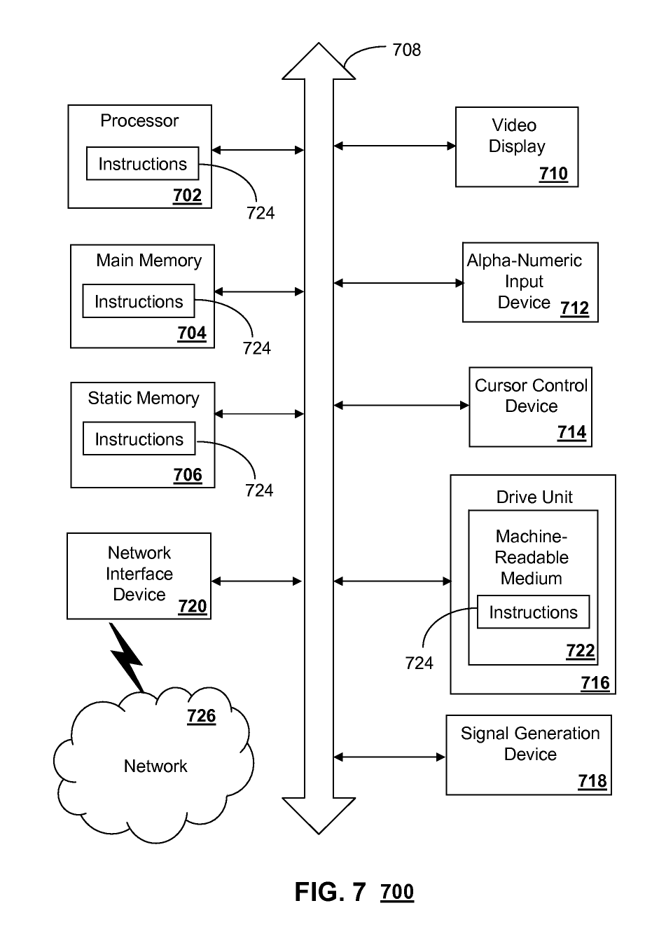

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A display server, comprising:
a controller that manages a display and a wireless transceiver, wherein the controller is programmed to:
transmit capabilities of the display over a wireless medium to a wireless communication device (WCD);
receive displayable content from the WCD according the capabilities of the display; and
present the displayable content on the display.

2. The display server of claim 1, wherein the controller is programmed to broadcast its presence within a local area network in which the WCD has roamed into.

3. The display server of claim 1, wherein the controller is programmed to transmit to the WCD the capabilities of the display upon detecting a discovery request from the WCD.

4. The display server of claim 1, wherein the controller is programmed to:
receive authentication information from the WCD; and
offer display services to the WCD upon validating the authentication information.

5. The display server of claim 1, wherein the displayable content comprises a plurality of screens, and wherein the controller is programmed to buffer and present the plurality of screens on the display.

6. The display server of claim 5, wherein the displayable content comprises at least one among a priority attribute and creation timestamp for each of the plurality of screens, and wherein the controller is programmed to present an order for each of the plurality of screens according to at least one among its priority attribute and its creation timestamp.

7. The display server of claim 1, wherein the controller is programmed to:
establish one or more timers according to the displayable content; and
terminate presentation of the displayable content upon expiration of at least one among the one or more timers.

8. The display server of claim 1, wherein the controller is programmed to manage operations of the display and the wireless transceiver to reduce power consumption.

9. The display server of claim 1, wherein the controller is programmed to establish a secure communication link with the WCD in response to a request from the WCD.

10. The display server of claim 1, comprising the display and the wireless transceiver, wherein the capabilities of the display server embodied in part in the display comprise at least one among a display type, a display resolution, one or more display dimensions, one or more content types supported by the display, a display speed, a display contrast ratio, one or more color parameters, and one or more interaction capabilities, wherein the wireless transceiver operates according to at least one among a plurality of wireless access technologies comprising Bluetooth, Wireless Fidelity (WiFi), Worldwide Interoperability for Microwave Access (WiMAX), Ultra Wide Band (UWB), software defined radio (SDR), and cellular communications, and wherein the controller is programmed to:
detect a second WCD;
assign at least one among temporal and spatial portions of the display to each of the first and second WCDs;
transmit capabilities of the display to the first and second WCDs according to their assigned portions;
receive displayable content from each of the first and second WCDs according the capabilities of their respective assigned portions; and
present the displayable content of each of the WCDs according to their respective assigned portions.

11. The display server of claim 1, wherein the display server is embodied in one among a plurality of form factors comprising a wristwatch, a personal digital assistant (PDA), an automobile dashboard, a television, a computer monitor, an entertainment system, and a security system, and wherein the controller is programmed to terminate presentation of the displayable content upon detecting at least one among a group of termination events comprising receiving from the WCD a request to terminate communications with the display server, an expiration of one or more timers that monitor at least one among a presentation time limit and a queuing time limit associated with the displayable content, and a loss of communications with the WCD.

12. The display server of claim 1, wherein the displayable content is presented as a screen on the display, and wherein the controller is programmed to modify the presentation of the screen in response to receiving from the WCD an update to the screen.

13. The display server of claim 1, comprising an audio system, wherein the displayable content comprises audible information, and wherein the controller is programmed to perform at least one among conveying audible signals corresponding to the audible information, and receiving audible signals from an end user of the WCD.

14. The display server of claim 1, comprising an input device to detect a tactile input from an end user of the WCD, wherein the controller is programmed to:
generate an interaction command in response to receiving a tactile entry from the end user;
transmit the interaction command to the WCD;
receive from the WCD an update to the displayable content according to the interaction command; and
present the updated displayable content.

15. A communication device, comprising:
a controller that manages operations of a wireless transceiver, wherein the controller is programmed to:
detect a display server in a wireless local area network (WLAN);
receive from the display server its capabilities for presenting content;
create displayable content conforming to the capabilities of the display server; and
transmit the displayable content to the display server.

16. The communication device of claim 15, wherein the controller is programmed to authenticate the communication device with the display server.

17. The communication device of claim 15, wherein the controller is programmed to transmit a request to the display server for a summary of its capabilities.

18. The communication device of claim 15, wherein the displayable content comprises a plurality of screens, and wherein the controller is programmed to transmit to the display server a plurality of priority attributes associated with the plurality of screens for prioritizing the presentation of the screens at the display server.

19. The communication device of claim 15, wherein the controller is programmed to transmit to the display server at least one among a presentation time limit and a queuing time limit for each of the plurality of screens.

20. The communication device of claim 15, wherein the controller is programmed to:
detect a second display server in the WLAN;
receive from the second display server its capabilities for presenting content;
generate first and second portions of the displayable content in accordance with the capabilities of the first and second display servers; and
transmit the portions of displayable content to the first and second display servers.

21. The communication device of claim 15, wherein the controller is programmed to:
update the displayable content according to one or more detectable events; and
transmit to the display server the updated displayable content.

22. The communication device of claim 15, wherein the controller is programmed to:
detect a second display server;
receive from the second display server its capabilities for presenting content;
select an appropriate one among the first and second display servers for presenting displayable content generated by an application operating in the controller;
generate displayable content conforming to the capabilities of the selected display server; and
transmit the displayable content to the selected display server.

23. The communication device of claim 15, wherein the capabilities of the display server include interaction commands generated in response to tactile inputs, and wherein the controller is programmed to:
include in the displayable content interaction commands conforming to the tactile input capabilities of the display server;
receive interaction commands from the display server according to tactile inputs from an end user;
update the displayable content according to the interaction commands received; and
transmit the updated displayable content to the display server.

24. A computer-readable storage medium in a media server, comprising computer instructions for:
transmitting functional parameters associated with media content capabilities of the media server to a detected wireless communication device (WCD); and
presenting media content received from the WCD conforming in part to the functional parameters of the media server.

25. A computer-readable storage medium in a wireless communication device, comprising computer instructions for:
detecting a media server in a wireless local area network;
receiving from the media server functional parameters associated with its media content capabilities;
generating media content in conformance with a portion of the functional parameters of the media server; and
transmitting the media content to the media server.
